(19) United States
(12) Patent Application Publication
(10) Pub. No.: US 2015/0372805 A1
(43) Pub. Date: Dec. 24, 2015

(54) ASYNCHRONOUS PULSE MODULATION FOR THRESHOLD-BASED SIGNAL CODING

(71) Applicant: QUALCOMM Incorporated, San Diego, CA (US)

(72) Inventor: Young Cheul YOON, San Diego, CA (US)

(21) Appl. No.: 14/513,997

(22) Filed: Oct. 14, 2014

Related U.S. Application Data
(60) Provisional application No. 62/015,739, filed on Jun. 23, 2014.

(51) Int. Cl. H04L 7/04; H04L 7/00

(52) U.S. Cl. CPC H04L 7/04; H04L 7/0016

(57) ABSTRACT

A method of signal processing includes comparing an input signal with one or more positive threshold values and one or more negative threshold values. The method also includes generating an output signal based on the comparison of the input signal with the positive threshold(s) and negative threshold(s). The method further includes feeding the output signal back into a decaying reconstruction filter to create a reconstructed signal and combining the reconstructed signal with the input signal.

### CROSS-REFERENCE TO RELATED APPLICATION

The present application claims the benefit of U.S. Provisional Patent Application No. 62/015,739, filed on Jun. 23, 2014, and titled “ASYNCHRONOUS PULSE MODULATION FOR THRESHOLD-BASED SIGNAL CODING,” the disclosure of which is expressly incorporated by reference herein in its entirety.

### BACKGROUND

1. Field

Certain aspects of the present disclosure generally relate to signal processing, and, more particularly, to asynchronous pulse modulation schemes for threshold-based signal coding.

2. Background

Signal encoding is employed in various systems, including telecommunications, sensors, signal processing chips and network designs. For example, signal encoding may be employed in audio and visual processors, between nodes in a distributed network, or between artificial neurons (i.e., neuron models) interconnected in a neural network. A neural network is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate.

Many systems employ a clock or timing device to sample data. Such systems may be called “synchronous” systems because the data is “synchronized” to the clock pulses or clock speed. Other systems may run without a clock, and such systems may be referred to as “asynchronous” because the data does not move through such systems in a periodic manner. Some networks, such as artificial neural networks, can infer a function from observations, and may be more computationally efficient or use lower power systems if they can be designed in an asynchronous manner.

### SUMMARY

In an aspect of the present disclosure, a method of signal processing is presented. The method includes comparing an input signal with one or more positive threshold values and one or more negative threshold values. The method also includes generating an output signal based on the comparison of the input signal with the positive threshold value(s) and the negative threshold value(s). The method further includes feeding the output signal back into a decaying reconstruction filter to create a reconstructed signal. Furthermore, the method includes combining the reconstructed signal with the input signal.

In another aspect of the present disclosure, an apparatus for signal processing is presented. The apparatus includes a memory and one or more processors coupled to the memory. The processor(s) is(are) configured to compare an input signal with one or more positive threshold values and one or more negative threshold values. The processor(s) is(are) also configured to generate an output signal based on the comparison of the input signal with the positive threshold value(s) and the negative threshold value(s). The processor(s) is(are) further configured to feed the output signal back into a decaying reconstruction filter to create a reconstructed signal. Furthermore, the processor(s) is(are) configured to combine the reconstructed signal with the input signal.

In yet another aspect of the present disclosure, an apparatus for signal processing is presented. The apparatus includes means for comparing an input signal with one or more positive threshold values and one or more negative threshold values. The apparatus also includes means for generating an output signal based on the comparison of the input signal with the positive threshold value(s) and the negative threshold value(s). The apparatus further includes means for feeding the output signal back into a decaying reconstruction filter to create a reconstructed signal. Furthermore, the apparatus includes means for combining the reconstructed signal with the input signal.

In still another aspect of the present disclosure, a computer program product for signal processing is presented. The computer program product includes a non-transitory computer readable medium having encoded thereon program code. The program code includes program code to compare an input signal with one or more positive threshold values and one or more negative threshold values. The program code also includes program code to generate an output signal based on the comparison of the input signal with the positive threshold value(s) and the negative threshold value(s). The program code further includes program code to feed the output signal back into a decaying reconstruction filter to create a reconstructed signal. Furthermore, the program code includes program code to combine the reconstructed signal with the input signal.

In an aspect of the present disclosure, a method of signal processing is presented. The method includes comparing an input signal with one or more threshold values. The method also includes generating an output signal based on the comparison of the input signal with the threshold value(s). The method further includes feeding the output signal back into a decaying reconstruction filter to create a reconstructed signal. The decaying reconstruction filter is other than a single decaying exponential. Furthermore, the method includes combining the reconstructed signal with the input signal.

In another aspect of the present disclosure, an apparatus for signal processing is presented. The apparatus includes a memory and one or more processors coupled to the memory. The processor(s) is(are) configured to compare an input signal with one or more threshold values. The processor(s) is(are) also configured to generate an output signal based on the comparison of the input signal with the threshold value(s). The processor(s) is(are) further configured to feed the output signal back into a decaying reconstruction filter to create a reconstructed signal. The decaying reconstruction filter is other than a single decaying exponential. Furthermore, the processor(s) is(are) configured to combine the reconstructed signal with the input signal.

In yet another aspect of the present disclosure, an apparatus for signal processing is presented. The apparatus includes means for comparing an input signal with one or more threshold values. The apparatus also includes means for generating an output signal based on the comparison of the input signal with the threshold value(s). The apparatus further includes means for feeding the output signal back into a decaying reconstruction filter to create a reconstructed signal. The decaying reconstruction filter is other than a single decaying exponential. Furthermore, the apparatus includes means for combining the reconstructed signal with the input signal.

In still another aspect of the present disclosure, a computer program product for signal processing is presented. The computer program product includes a non-transitory computer readable medium having encoded thereon program code. The program code includes program code to compare an input signal with one or more threshold values. The program code also includes program code to generate an output signal based on the comparison of the input signal with the threshold value(s). The program code further includes program code to feed the output signal back into a decaying reconstruction filter to create a reconstructed signal. The decaying reconstruction filter is other than a single decaying exponential. Furthermore, the program code includes program code to combine the reconstructed signal with the input signal.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network in accordance with certain aspects of the present disclosure.

FIG. 2 illustrates an example network of neurons in accordance with certain aspects of the present disclosure.

FIG. 3 illustrates an example of a processing unit (neuron) of a computational network (neural system or neural network) in accordance with certain aspects of the present disclosure.

FIG. 4 illustrates an Asynchronous Pulse Modulator (APM) in accordance with an aspect of the present disclosure.

FIG. 5 is a graph illustrating an exemplary multiple threshold quantization approach without decay in accordance with aspects of the present disclosure.

FIG. 6 is a block diagram illustrating an exemplary APM in accordance with an aspect of the present disclosure.

FIG. 7 shows graphs that illustrate the operation of an exemplary APM with an upper-threshold quantizer in accordance with aspects of the present disclosure.

FIG. 8 is a block diagram illustrating an exemplary APM in accordance with aspects of the present disclosure.

FIG. 9 shows graphs that illustrate the operation of an exemplary APM with a lower-threshold quantizer in accordance with aspects of the present disclosure.

FIG. 10 is a block diagram illustrating an exemplary APM in accordance with aspects of the present disclosure.

FIG. 11 shows graphs that illustrate the operation of an exemplary APM with a double-sided quantizer in accordance with aspects of the present disclosure.

FIG. 12 is a block diagram illustrating a simplified APM in accordance with aspects of the present disclosure.

FIG. 13 is a block diagram illustrating an exemplary APM including a reset mechanism in accordance with aspects of the present disclosure.

FIGS. 14-15 are flow diagrams illustrating methods for signal encoding in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, the present disclosure may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Asynchronous Pulse Modulation

Input data streams to neural networks, as well as other networks, may be continuous in nature. Clock-based systems sample a continuous-time signal regularly (periodically), which may result in sampling of the signal even in the absence of a change in the signal. Such an approach may use additional power or limit the overall speed of such systems.

Aspects of the present disclosure are directed to signal processing with asynchronous pulse modulation. In some aspects, the signal processing may be conducted without the use of a clock signal.

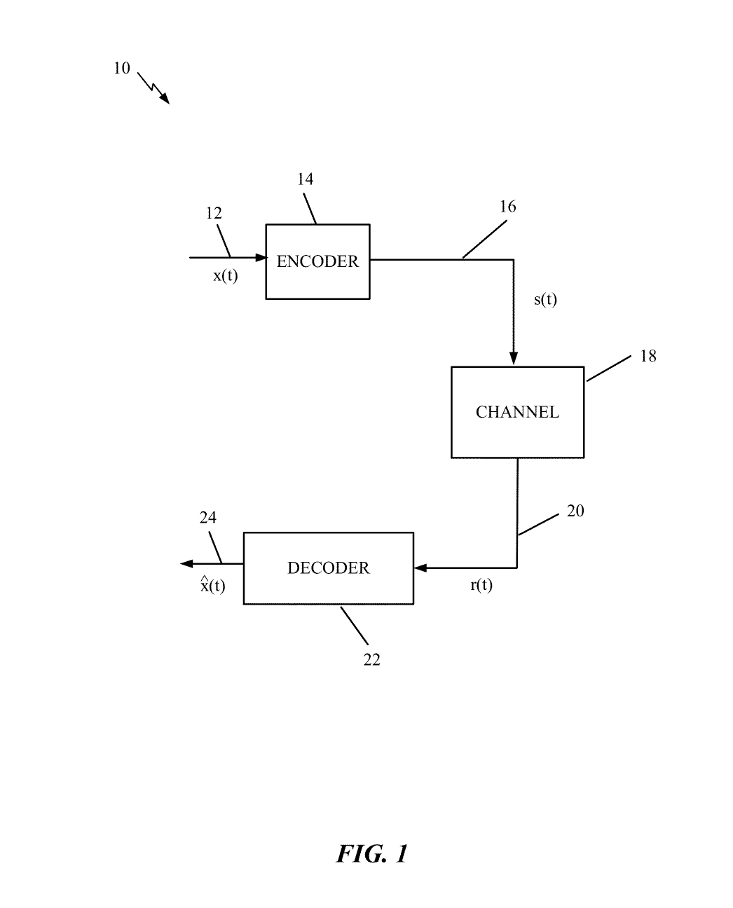

FIG. 1 illustrates an example network in accordance with certain aspects of the present disclosure.

In communications systems, including computers, cellular telephones, networks, etc., encoding is a process that places an input signal or sequence into a different format for transmission or storage. For example, a system 10 may process an input 12 (e.g., x(t)) through an encoder 14. The input 12 may be an analog signal, a digital signal, a phase or pulse modulated signal, or other type of signal. As an example, an analog audio signal may be encoded into a digital signal through an analog-to-digital converter. The output 16 from the encoder 14 is transmitted through a channel 18, which may be wireless or via wires, optical fibers, or other transmission media.

The output 20 of the channel 18 may then be provided to a decoder 22, which converts the output 20 back into the original input 12. The decoder 22 has an output 24 that is a reproduction of the input 12. Depending on the precision of the encoder 14, losses or noise in the channel 18, and the matching of the decoder 22 to the encoder 14, the output 24 may vary from the input 12. For example, if the channel 18 is noisy, the output 24 may not be an exact reproduction of the input 12.

Many different encoding/decoding schemes may be used. Quadrature pulse shift keying (QPSK) codes, differential signals, pseudorandom (PN) coding, time division, and other signal encoding schemes may be employed by the encoder 14 and the decoder 22. In data communications, Manchester encoding may be used, where binary digits (bits) represent the transitions between high and low logic states.

The present disclosure addresses the problem of implementing or realizing an asynchronous system employing pulse modulation to encode continuous-time signals into events and/or decode the events back into an estimate of the continuous-time signal. The present disclosure describes, in an aspect, an asynchronous pulse modulation (APM) design for clock-optional and efficient signal encoding. A clock-free design operates in continuous-time. A design where a clock is present or available may operate in discrete-time.

A design in accordance with aspects of the present disclosure enables the realization of new encoders in a generalized framework. For example, positive unipolar, negative unipolar, bipolar and multi-valued signaling, decaying reconstruction (delta) filters, pre (sigma) filters for signal shaping and a simplified design where only an anti-aliasing filter is used at the decoder are all possible within the present disclosure.

The present disclosure provides more efficient encoding of continuous-time signals over channels. For example, in an ideal channel with no noise or signal attenuation, the continuous-time signal could be transmitted directly (akin to the gap junction in neurons). However, in practice, the fidelity of this direct approach suffers given channels subject to non-idealities and the received signal can be distorted.

### An Example Neural System, Training and Operation

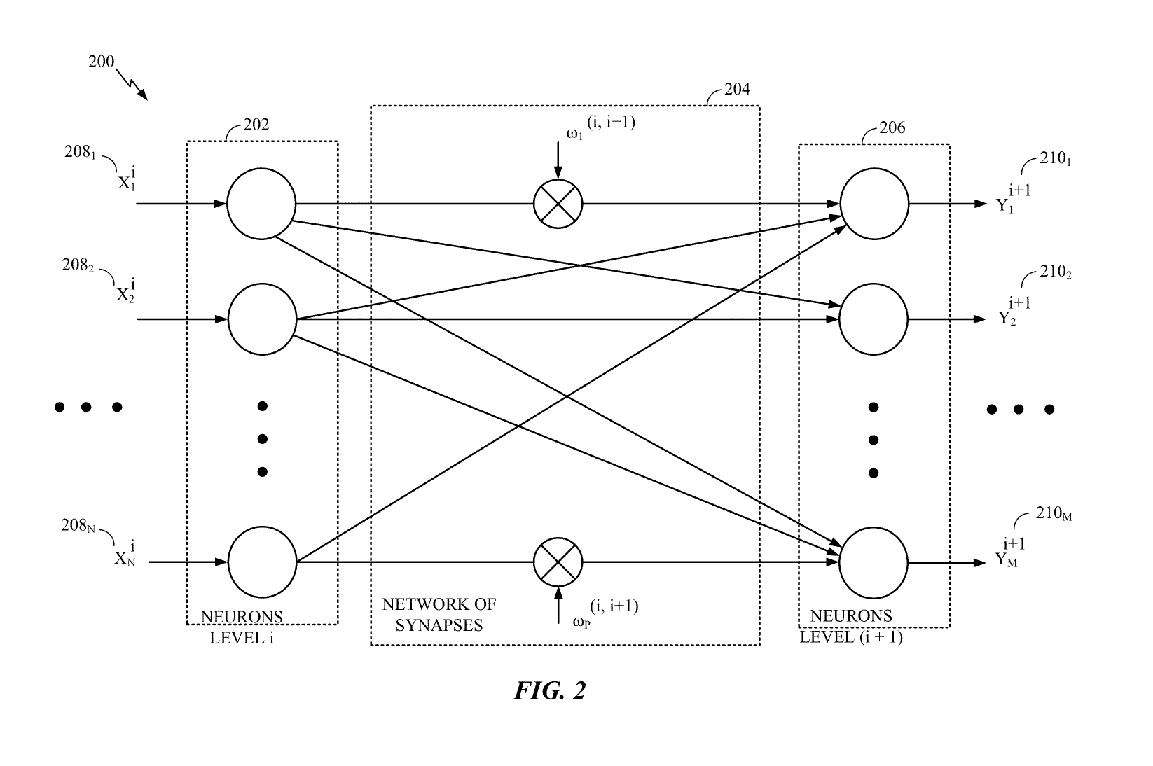

FIG. 2 illustrates an example artificial neural system 200 with multiple levels of neurons in accordance with certain aspects of the present disclosure. A type of system 10 shown in FIG. 1 may be a neural system that has several inputs, several channels, and several outputs arranged in “levels” or “tiers.” The neural system 200 may have a level 202 of neurons connected to another level of neurons 206 through a network of synaptic connections 204 (i.e., feed-forward connections). For simplicity, only two levels of neurons are illustrated in FIG. 2, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 2, each neuron in the level 202 may receive an input signal 208 that may be generated by neurons of a previous level (not shown in FIG. 2). The input signal 208 may represent an input current of the level 202 neuron. This current may be accumulated on the neuron membrane to charge a membrane potential. When the membrane potential reaches its threshold value, the neuron may fire and generate an output spike to be transferred to the next level of neurons (e.g., the level 206). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 2), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 204, as illustrated in FIG. 2. Relative to the synapses 204, neurons of level 202 may be considered presynaptic neurons and neurons of level 206 may be considered postsynaptic neurons. The synapses 204 may receive output signals (i.e., spikes) from the level 202 neurons and scale those signals according to adjustable synaptic weights w₁^{(i,i+1)}, . . . , w_{P}^{(i,i+1)} where P is a total number of synaptic connections between the neurons of levels 202 and 206 and “i” is an indicator of the neuron level. In the example of FIG. 2, i represents neuron level 202 and i+1 represents neuron level 206. Further, the scaled signals may be combined as an input signal of each neuron in the level 206. Every neuron in the level 206 may generate output spikes 210 based on the corresponding combined input signal. The output spikes 210 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 200 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 200 may be utilized in a large range of applications, such as image and pattern recognition, machine learning, motor control, and alike. Each neuron in the neural system 200 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 204 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 200 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

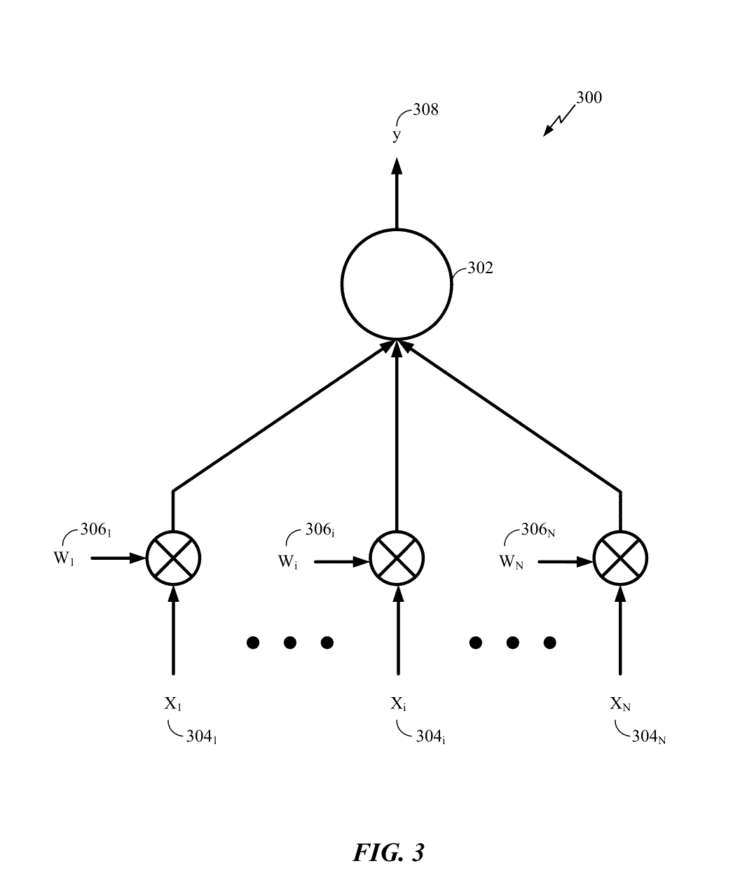

FIG. 3 illustrates an exemplary diagram 300 of a processing unit (e.g., a neuron or neuron circuit) 302 of a computational network (e.g., a neural system or a neural network) in accordance with certain aspects of the present disclosure. For example, the neuron 302 may correspond to any of the neurons of levels 202 and 206 from FIG. 2. The neuron 302 may receive multiple input signals 304₁-304_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 302 through synaptic connections that scale the signals according to adjustable synaptic weights 306₁-306_{N} (W₁-W_{N}), where N may be a total number of input connections of the neuron 302.

The neuron 302 may combine the scaled input signals and use the combined scaled inputs to generate an output signal 308 (i.e., a signal Y). The output signal 308 may be a current, a conductance, a voltage, a real-valued and/or a complex-valued. The output signal may be a numerical value with a fixed-point or a floating-point representation. The output signal 308 may be then transferred as an input signal to other neurons of the same neural system, or as an input signal to the same neuron 302, or as an output of the neural system.

The processing unit (neuron) 302 may be emulated by an electrical circuit, and its input and output connections may be emulated by electrical connections with synaptic circuits. The processing unit 302 and its input and output connections may also be emulated by a software code. The processing unit 302 may also be emulated by an electric circuit, whereas its input and output connections may be emulated by a software code. In an aspect, the processing unit 302 in the computational network may be an analog electrical circuit. In another aspect, the processing unit 302 may be a digital electrical circuit. In yet another aspect, the processing unit 302 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 2 and/or the weights 306₁-306_{N} from FIG. 3) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not use plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

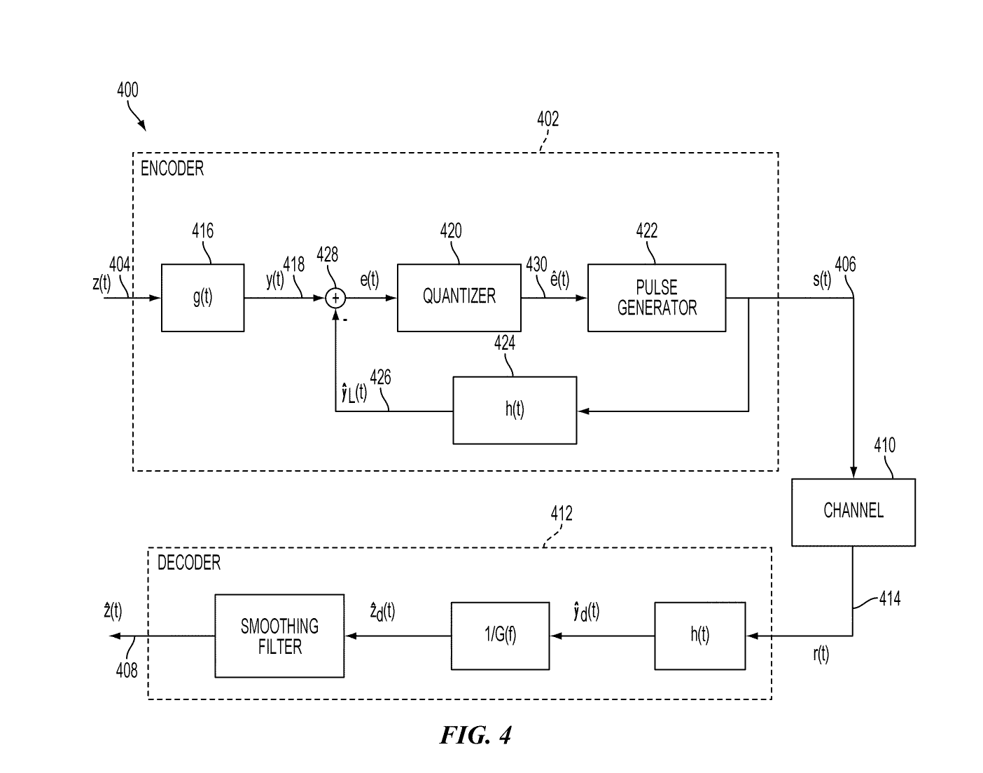

FIG. 4 illustrates an asynchronous pulse modulator (APM) in accordance with an aspect of the present disclosure. FIG. 4 illustrates an APM 400 employing an encoder 402 to encode an input signal z(t) 404 into a transmit signal s(t) 406 and reconstructs an estimate \hat{z}(t) 408 of the input signal 404 across a channel 410 at a decoder 412. The channel 410 may be assumed as an ideal channel for ease in explanation such that the received signal 414 at the decoder 412 r(t)=s(t) with the understanding that channel noise and distortion (e.g., multipath channels, time-varying attenuation) can be introduced and affect system design.

In some aspects, the encoder 402 may include a linear time-invariant (LTI) pre-filter 416 g(t) for pre-shaping the input signal 404 z(t) and generating a filtered signal 418:

y(t)=z(t)*g(t) (1)

The LTI pre-filter 416 may be referred to as a “sigma” or integrating filter. If the LTI pre-filter 416 is present, then the APM 400 may be referred to as an asynchronous pulse sigma-delta modulator (APSDM). If the LTI pre-filter 416 is absent, then y(t)=z(t) and the APM may be referred to as an asynchronous pulse delta modulator (APDM).

The encoder 402 also includes a quantizer 420, a signal generator 422 (which may be a pulse generator), and a reconstruction filter 424. The quantizer 420, the signal generator 422, and the reconstruction filter 424 in combination may be referred to as a generalized asynchronous pulse delta modulator (APDM) encoder that encodes changes or “deltas” in the filtered signal 418 y(t). The filtered signal 418 y(t) is supplied to an adder 428 and subtracted by a local reconstruction signal 426 ŷ_{L}(t) to generate a difference signal:

e(t)=y(t)−ŷ_{L}(t). (2)

The amplitude of the difference signal is quantized by the quantizer 420 yielding the signal 430:

\hat{e}(t)=Q[e(t)]. (3)

Though the signal e(t) may be continuous-valued, in some aspects, it may take on one or more discrete values. The quantizer 420 can also take a number of forms. For example, as described in more detail later, the quantizer can have one, two or multiple thresholds. The quantized difference signal 430 ê(t) is then passed through the signal generator 422 to produce the transmit signal 406:

s(t)=Σₘ₌₁^{M}a(m)p(t−Tₘ), (4)

where M represents the total number of output pulses generated by the encoder, p(t) represents the transmit pulse shape with unit energy, Tₘ is the time instant associated with the mth occurrence of a positive change (reaching or exceeding an upper threshold) and/or a negative change (reaching or exceeding a lower threshold) in ê(t) where mε[1,M] and T₁<T₂< . . . <T_{M}, and a(m) is a scaling value or factor associated with the mth pulse. For example, a(m) may represent 1 or any positive or negative set of values (e.g., ±1, ±2).

In one aspect, the pulses may have large bandwidth that resembles an impulse function δ(t). These include pulses like sinc(Bt) where B>>1, the raised cosine pulse described later (with Bₘ>>1 and roll-factor of β) and a thin rectangular pulse

$$\frac{1}{{T}^{( p )}} [ {u}_{s} ( t ) - {u}_{s} ( t - {T}^{( p )} ) ]$$

where T^{(p)}<<1 and uₛ(t) is the unit step function:

$${u}_{s} ( v ) = \{ \begin{matrix}0 , & v < 0 \\ 1 , & v \geq 0\end{matrix} \qquad ( 5 )$$

In some aspects, the transmit signal 406 may be viewed as a transformation of the time-instant sequence {T₁, T₂, . . . , T_{M}} when thresholds are reached to a train of pulses. The transmit signal 406 may also be thought of as pulse time modulation, where each time instant determines the instant the pulse is generated.

The transmit signal 406 may then be fed back into the reconstruction filter 424 h(t) (also referred to as a Delta filter) to yield the reconstruction signal 426:

ŷ_{L}(t)=s(t)*h(t) (6)

ŷ_{L}(t)=Σₘ₌₁^{M}a(m)h(t−Tₘ). (7)

For continuous-time systems, a clock is not used and the signaling time instants {Tₘ|mε[1,M]} are continuous valued. On the other hand, for discrete-time systems which may use a clock, the signal time instants {Tₘ|mε[1,M]}, may be quantized (e.g., to the nearest 1 ms). This yields discrete-time versions of the APM 400.

In some aspects, the quantizer 420 and signal generator 422 may be combined if desired. Furthermore, a smoothing filter 432 (e.g., an anti-aliasing filter (AAF)) may be inserted prior to the pre-filter to remove out-of-band noise. The smoothing filter 432 may be a low-pass filter (LPF) or band-pass filter (BPF), for example. In some aspects, the bandwidth of the smoothing filter 432 may be set to approximate the bandwidth of z(t).

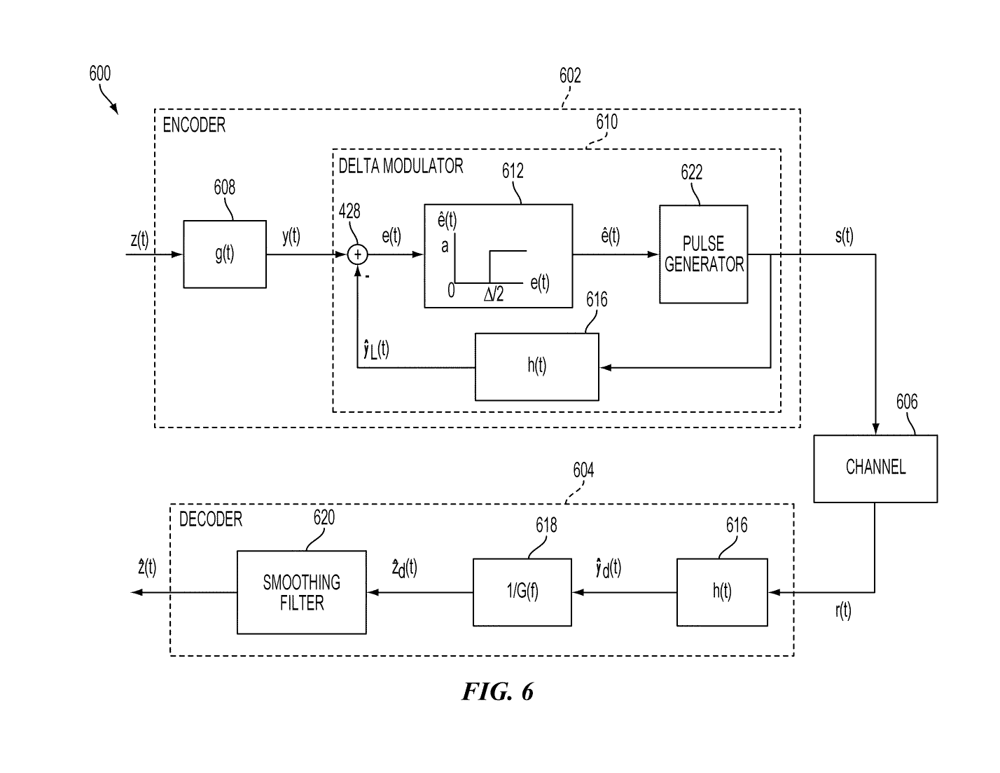

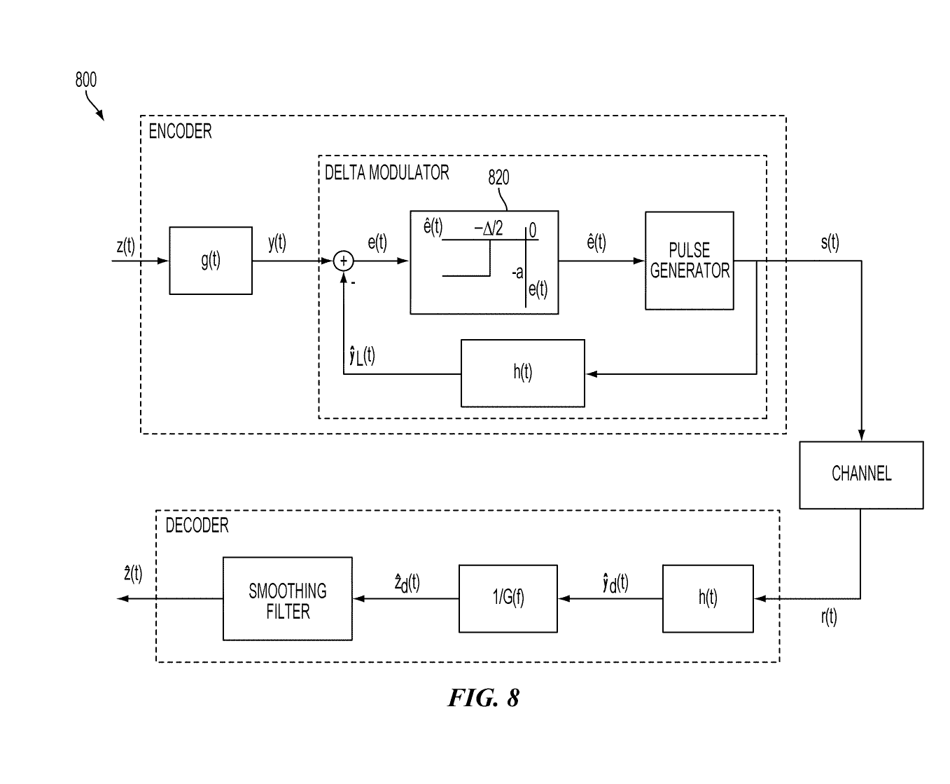

The quantizer 420 may be provided in a variety of configurations. For example, the quantizer 420 may be single-sided or double-sided. A single-sided quantizer may, for instance, include an upper-threshold quantizer (shown in FIG. 6) or a lower-threshold quantizer (shown in FIG. 8).

Upper-threshold quantizers may encode signals with a minimum value, which may, for instance, be zero. Upper-threshold quantizers may have a single threshold or multiple thresholds for quantization of input signals.

The difference signal is mapped to the quantized difference signal via:

$$\hat{e} ( t ) {=}^{Δ} a {u}_{s} [ e ( t ) - \frac{Δ}{2} ] , \qquad ( 8 )$$

such that ê(t)ε{0,a}, ê(t)=a if e(t)≧Δ/2 and ê(t)=0, otherwise where a>0 represents the quantized value. For ease of explanation, and without limitation, the scaling factor a may be set to 1. Accordingly, the quantizer 420 may produce transmit signals in the form of single positive-valued pulse trains scaled by a factor of a (e.g., similar to spikes in spiking neural networks) which may also be referred to as unipolar signaling or point processes. The transmit signals may be given by:

s(t)=aΣₘ₌₁^{M}δ(t−Tₘ). (9)

In some aspects, the design of the threshold value impacts the reconstruction filter design. In one example, a threshold value of Δ/2 and an h(t)ε[0,Δ] defined later may produce an e(t)

$$∈ [ - \frac{Δ}{2} , \frac{Δ}{2} ] .$$

In another example, a threshold value of Δ and an h(t)ε[0,Δ] may produce e(t)ε[0,Δ]. The first approach results in smaller absolute values of the difference signal. This comment applies not only to the upper-threshold quantizers but to all quantizers described in this document.

The time instants {Tₘ|m=1, . . . , M} correspond to the instants that ê(t) is above or equal to the threshold.

Multiple positive thresholds can be introduced to handle input signals with fast positive-valued changes, where e(t)>>Δ/2, which can occur if e(t) changes quickly during a down-time or refractory period during which the encoder may not transmit (e.g., due to recharging of power resources). An example of a double-threshold single-sided quantizer is described below.

The difference signal is mapped to the quantized difference signal via:

$$\hat{e} ( t ) {=}^{Δ} \{ \begin{matrix}a , & if Δ / 2 \leq e ( t ) < 3 Δ / 2 \\ 2 a , & if e ( t ) \geq 3 Δ / 2 \\ 0 , & otherwise\end{matrix} , \qquad ( 10 )$$

such that ê(t)ε{0,a,2a}. This quantizer results in transmit signals in the form of two discrete-valued pulse trains. These result in transmit signals of the form:

s(t)=Σₘ₌₁^{M}a(m)δ(t−Tₘ), (11)

where a(m)ε{a,2a}. The time instants {Tₘ|m=1, . . . , M} correspond to the instants that ê(t) is above a threshold.

Lower-threshold quantizers are intended for encoding signals below a maximum value. For ease in explanation, we assume a maximum value of 0 such that the encoding is for non-positive signals. Lower-threshold quantizers may also have one or more thresholds for quantizing input signals.

The difference signal may be mapped to the quantized difference signal via:

$$\hat{e} ( t ) {=}^{Δ} a {u}_{s} [ - e ( t ) - \frac{Δ}{2} ] ,$$

such that ê(t)ε{0,−a} and ê(t)=−a if e(t)≦−Δ/2 and ê(t)=0, otherwise. The value a represents the quantized value (e.g., a=1). This quantizer results in transmit signals in the form of single negative-valued pulse trains that may be given by:

s(t)=−aΣₘ₌₁^{M}δ(t−Tₘ), (13)

where the time instants {Tₘ|m=1, . . . , M} correspond to the instants that ê(t) is below or equal to the threshold.

As with the upper-threshold threshold quantizers, multiple lower-threshold thresholds can be introduced to handle input signals with fast negative-valued changes, where e(t)<<−Δ/2.

The difference signal is mapped to the quantized difference signal via.

$$\hat{e} ( t ) {=}^{Δ} \{ \begin{matrix}- a , & if - \frac{3 Δ}{2} < e ( t ) \leq - Δ / 2 \\ - 2 a , & if e ( t ) \leq - 3 Δ / 2 \\ 0 , & otherwise\end{matrix} . \qquad ( 14 )$$

This results in transmit signals of the form:

s(t)=Σₘ₌₁^{M}a(m)δ(t−Tₘ), (15)

where a(m)ε{−a,−2a}. The time instants {Tₘ|m=1, . . . , M} correspond to the instants that ê(t) is below or equal to a thresholds.

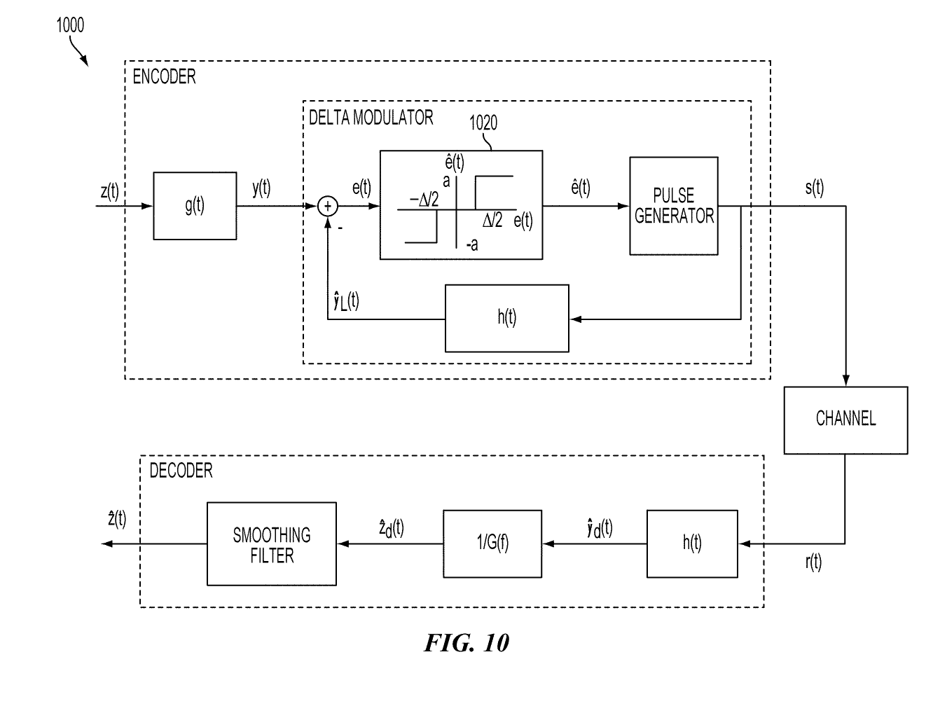

A double-sided quantizer (e.g., shown in FIG. 10) may encode signals that may not have a minimum or maximum. Double-sided quantizers may have both increasing and decreasing valued thresholds. Such quantizers can support the quantization of signals that are unbounded and, if desired, upper-threshold and/or lower-threshold. A double-sided single-threshold-pair quantizer is shown in FIG. 10.

The difference signal is mapped to the quantized difference signal via:

$$\hat{e} ( t ) = \{ \begin{matrix}- a , & if e ( t ) \leq - Δ / 2 \\ a , & if e ( t ) \geq Δ / 2 \\ 0 , & otherwise\end{matrix} , \qquad ( 16 )$$

such that ê(t)ε{−a,0,a}. This quantizer results in transmit signals in the form of bipolar pulse trains:

s(t)=Σₘ₌₁^{M}a(m)δ(t−Tₘ), (17)

where a(m)ε{−a,a}. The time instants {Tₘ|m=1, . . . , M} correspond to the instants that ê(t) is either above or equal to the positive-valued threshold or below or equal to the negative-valued threshold.

Multiple threshold pairs can be introduced to handle fast changing input signals with |e(t)|>>Δ/2. An example of a double-sided double-threshold-pair quantizer is described below.

The difference signal is mapped to the quantized difference signal via:

$$\hat{e} ( t ) = \{ \begin{matrix}- 2 a , & if e ( t ) \leq - 3 Δ / 2 \\ - a , & if - 3 Δ / 2 < e ( t ) \leq - Δ / 2 \\ a , & if Δ / 2 < e < 3 Δ / 2 \\ 2 a , & if e ( t ) \geq 3 Δ / 2 \\ 0 , & otherwise\end{matrix} , \qquad ( 18 )$$

such that ê(t)ε{0,a,2a}. This quantizer results in transmit signals in the form of bipolar pulse trains:

s(t)=Σₘ₌₁^{M}a(m)δ(t−Tₘ), (19)

where a(m)ε{−2a,−a,a,2a}. The time instants {Tₘ|m=1, . . . , M} correspond to the instants that ê(t) is either above or equal to a positive-valued threshold or below or equal to a negative-valued threshold.

If the quantizer 420 is single-sided, then the reconstruction filter 424 may be a decaying filter. A non-decaying reconstruction filter may result in reconstruction signals 426 that are either monotonically increasing for upper-threshold quantizers or monotonically decreasing for lower-threshold quantizers. If the quantizer 420 is double-sided, then either decaying or non-decaying reconstruction filters 424 may be used. A decaying reconstruction filter 424 may have continuous-values or discrete-values.

A non-decaying reconstruction filter may take on the impulse response:

$$h ( t ) {=}^{Δ} \frac{Δ}{a} {u}_{s} ( t ) , \qquad ( 20 )$$

where a scaling factor 1/a may be applied to remove the factor a in the transmit (or receive) signal and scaling factor Δ may be used to track the input signal by an amount matching that defined by the quantizer. In some aspects, Δ=a=1 such that h(t)=uₛ(t).

In some configurations, an arbitrary decaying filter with continuous-valued impulse response may be used. For example, an arbitrary decaying filter may be used when the signal (e.g., input signal) tapers down to zero. In some aspects, the reconstruction filter may be selected based on the decay behavior of the input signal type. For example, for fast decaying input signals, reconstruction filters with fast decays to zero may be used. Otherwise, reconstruction filters with slow decays may be used. For signals with fast rises, reconstruction filters with fast rises may be employed. Otherwise, reconstruction filters with slow rises could be used.

A simple decaying reconstruction filter is the decaying exponential:

$$h ( t ) {=}^{Δ} \frac{Δ}{a} \cdot exp ( - t / {τ}_{d} ) {u}_{s} ( t ) , \qquad ( 21 )$$

where τ_{d} represents the decay time constant and where uₛ(t) represents the unit-step function such that uₛ(t)=1 if t≧0 and uₛ(t)=0, otherwise.

In some aspects, a reconstruction filter with a double exponential may be used. For example, for a smooth rise, rather than an abrupt jump, the double exponential filter may be given by:

$$h ( t ) {=}^{Δ} \frac{Δ}{a} \cdot {A}_{2 exp} ( {e}^{- t / {τ}_{d}} - {e}^{- t / {τ}_{r}} ) \cdot {u}_{s} ( t ) , \qquad ( 22 )$$

where τᵣ represents the rise time constant and the scaling coefficient A₂ₑₓₚ is:

A₂ₑₓₚ [symbol] A_{2exp,peak}/(e^{-T}^{ₚₑₐₖ}^{/τ}^{_{d}}−e^{-T}^{ₚₑₐₖ}^{/τ}^{ᵣ}), (23)

where A_{2exp,peak} represents the peak magnitude of the double exponential (e.g., A_{2exp,peak}=1) and:

$${T}_{peak} {=}^{Δ} \frac{{τ}_{d} {τ}_{r}}{{τ}_{d} - {τ}_{r}} log ( \frac{{τ}_{d}}{{τ}_{r}} ) . \qquad ( 24 )$$

In some aspects, decaying filters with discrete-values may be employed. In one example, the reconstruction filter has the form of a linear decaying staircase function with uniformly spaced discrete values.

The reconstruction filter may also have non-uniformly spaced discrete values and non-uniform durations for each discrete value. In one example, a reconstruction filter with decreasing step sizes adjusted in a telescoping fashion (factor of ½) which can be likened to a discrete-valued version of the decaying exponential may be used.

In still another aspect, the reconstruction filter may have an initial rise and a subsequent decay. For instance the reconstruction filter may initially rise and then have a decaying staircase function that can be likened to a discrete-valued version of the double exponential.

If the channel 410 is ideal (i.e., has no losses or noise), then the decoder 412 sees a received signal 414 equivalent to the transmit signal 406 such that r(t)=s(t).

With APDM and single-sided quantizers for encoding bounded signals, the reconstruction signal (or filter impulse response) may generally tend towards zero. Otherwise, signal encoding may not be possible. For example, APDM with an upper-threshold quantizer and reconstruction filter set to the unit-step function may only encode signals that increase with time and may not encode signals that also decrease with time. On the other hand, a reconstruction filter with a response that tends towards zero sufficiently fast may encode signals that also decay.

The decoder 412 may include a reconstruction filter (similar to the reconstruction filter 424), an inverse filter, and a smoothing filter 432 (e.g., an anti-aliasing filter (AAF)), which, in some aspects, may be configured in a different order and/or combined.

In the APM 400 of the present disclosure, there is an explicit solution for the decoder 412, rather than an estimated numerical solution for the impulse response.

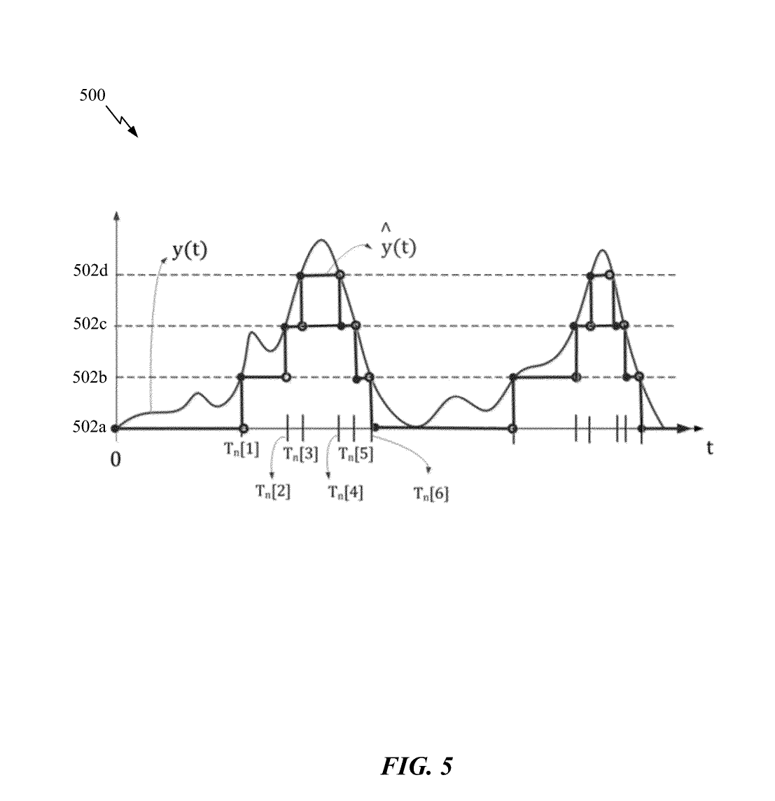

FIG. 5 is a graph 500 illustrating an exemplary multiple threshold quantization approach with a reconstruction filter with a unit-step function impulse response in accordance with aspects of the present disclosure. Referring to FIG. 5, a varying input signal y(t) crosses various thresholds (e.g., 502a, 502b, 502c, and 502d) at different time instances. As the input signal y(t) crosses a threshold, a level-crossing event occurs that triggers sampling of the input signal at the time instance of the crossing (e.g., Tₙ[1]-Tₙ[6]). That is, the input signal y(t) becomes the quantized signal ŷ(t) when the input signal crosses the various thresholds at the times Tₙ[1] through Tₙ[6]. If one of the threshold crossings is not detected, then the quantized signal will be in error, and the error will not be correctable, as the non-decaying reconstruction filter 424 will not return the quantized signal to the input signal.

FIG. 6 is a block diagram illustrating an exemplary APM 600 in accordance with an aspect of the present disclosure. The exemplary APM 600 may include an encoder 602 and decoder 604. The encoder 602 includes a pre-filter 608 (e.g., a sigma filter) and an asynchronous delta modulator (ADM) 610. The ADM 610 includes a upper-threshold quantizer 612, a pulse generator 622 and a reconstruction filter 616.

The encoder 602 receives an input signal z(t). The input signal may be filtered via the pre-filter 608 and supplied to the ADM 610. The filtered input signal y(t) is supplied to the summer 428. The summer produces a difference signal e(t) that is provided to the upper-threshold quantizer 612. In the example of FIG. 6, the upper-threshold quantizer 612 is configured with a single threshold. However, as described above, additional thresholds may also be included.

When the difference signal (e(t)) crosses the single threshold level, the quantizer supplies a quantized signal to the pulse generator, which in turn generates pulses (s(t)) (e.g., spikes). The generated pulses (s(t)) may be transmitted to the decoder 604 via a channel 606. In some aspects, the transmitted pulses may be positive-valued changes. Notably, the pulses are transmitted on an event basis, (e.g., when the difference signal reaches a threshold level), and thus, the APM may be operated without the use of a clock. Accordingly, the APM may beneficially provide a reduction in computational complexity and power consumption.

The generated pulses are also provided to a reconstruction filter 616 (h(t)) which generates a reconstructed input signal ŷ_{L}(t). The reconstructed input signal is in turn supplied as feedback to the ADM 610 and used to compute the difference signal e(t).

The decoder 604 includes a reconstruction filter 616, an inverse filter 618 and a smoothing filter 620. The smoothing filter 620 may, for example, be an anti-aliasing filter. The smoothing filter 620 may reduce harmonics introduced by the quantizer 612 during quantization of the input signal.

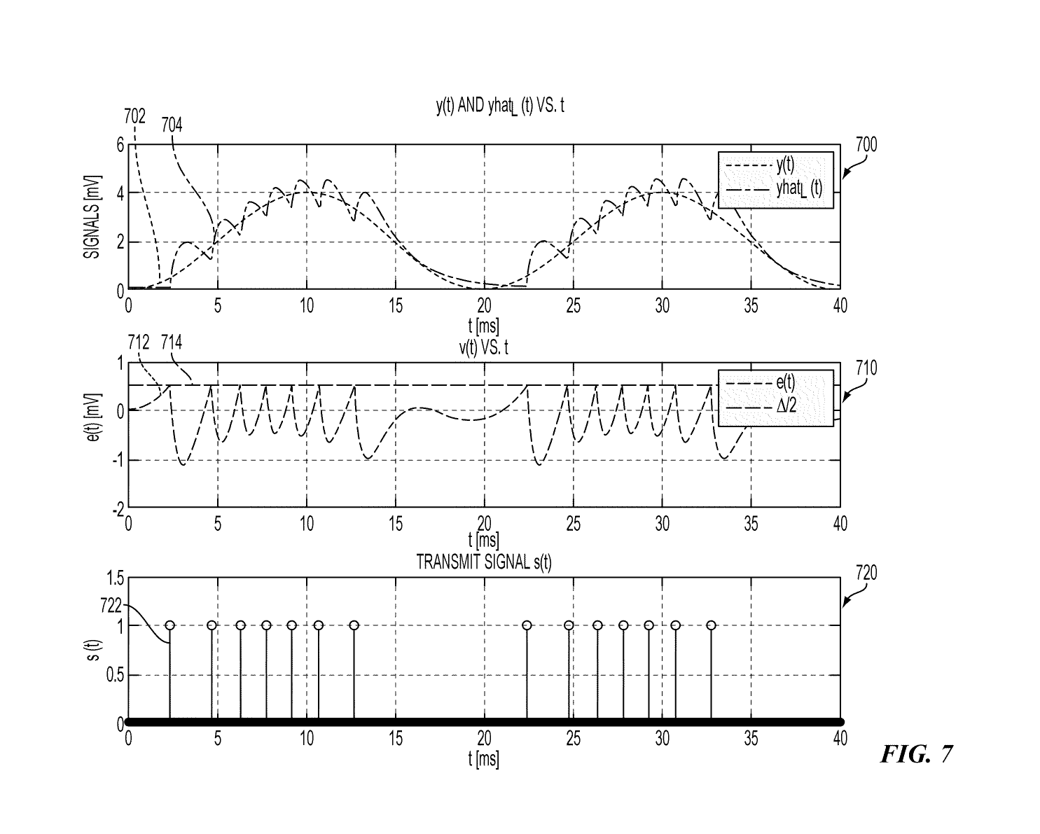

FIG. 7 shows graphs illustrating operation of an exemplary APM with a upper-threshold quantizer in accordance with aspects of the present disclosure. In the upper graph 700 of FIG. 7, a sinusoidal input signal 702 is superimposed with the reconstruction signal 704. The input signal y(t) may, for example, take the form of a positive valued sinusoid given by:

$$y ( t ) = 2 + 2 sin ( 2 π {f}_{c} t - \frac{π}{2} ) . \qquad ( 25 )$$

The reconstruction signal ŷ_{L}(t) 704 may be produced via a double exponential reconstruction filter, such as that provided in equation (22), for example.

The middle graph 710 shows the difference signal e(t) 712 computed based on the input signal 702 and the reconstruction signal 704. In this example, the upper-threshold quantizer includes a single threshold

$$( \frac{Δ}{2} ) ,$$

which is shown by way of the line 714. When the difference signal 712 reaches the threshold 714, a quantized difference signal is produced and provided to the pulse generator (e.g., 622). In the bottom graph 720, pulses generated by the pulse generator are shown. As such, when the difference signal 712 reaches the threshold, the pulse generator generates a corresponding transmit signal in the form of a pulse 722.

FIG. 8 is a block diagram illustrating an exemplary APM 800 in accordance with aspects of the present disclosure. The APM 800 includes similar elements and components to those shown in FIG. 6. Notably, the APM 800 includes an lower-threshold quantizer 820. The quantizer 820 includes a single threshold. Of course as discussed above, additional threshold values could also be used.

In this exemplary APM 800, the quantizer 820 encodes negative changes in the difference signal e(t) to generate transmit pulses that are negative valued. In some aspects, positive valued transmit pulses may be generated by setting the threshold value to a negative value and the reconstruction filter h(t) may be set to a negative value impulse function which tapers to zero from below.

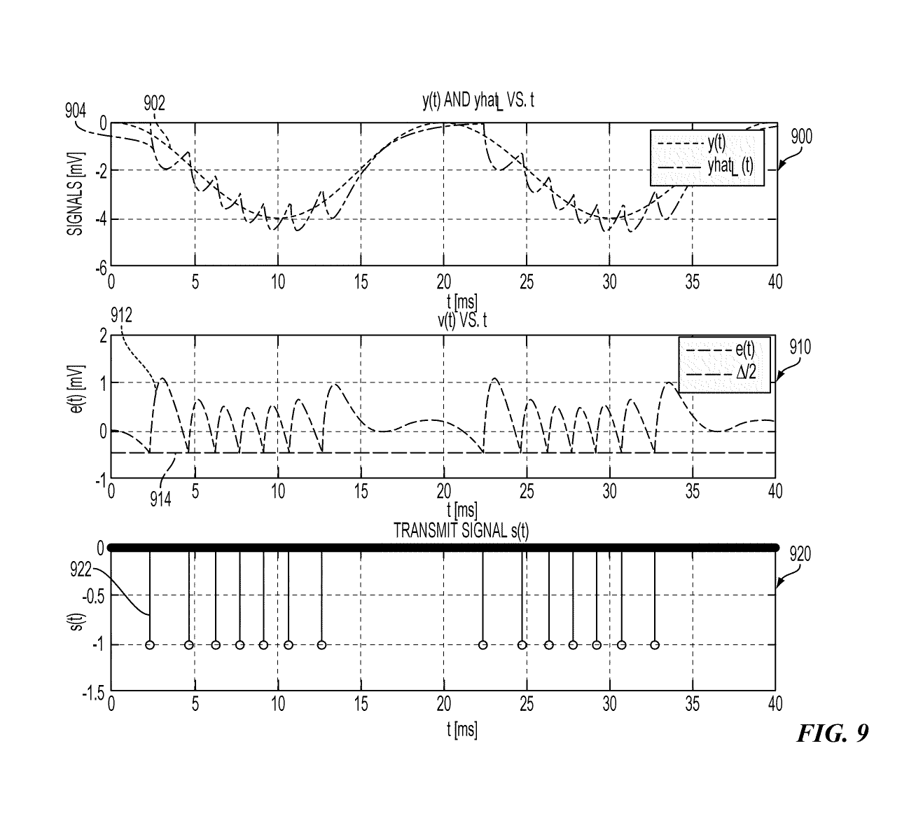

FIG. 9 shows graphs illustrating operation of an exemplary APM with an lower-threshold quantizer, in accordance with aspects of the present disclosure. In the upper graph 900 of FIG. 9, a sinusoidal input signal 902 is superimposed with a reconstruction signal 904. The input signal y(t) may, for example, take the form of a negative valued sinusoid given by:

$$y ( t ) = - 2 - 2 sin ( 2 π {f}_{c} t - \frac{π}{2} ) . \qquad ( 26 )$$

The reconstruction signal ŷ_{L}(t) 904 may be produced via a double exponential reconstruction filter, such as that provided in equation (22), for example.

The middle graph 910 shows the difference signal e(t) 912 computed based on the input signal 902 and the reconstruction signal 904. In this example, the lower-threshold quantizer includes a single threshold

$$( \frac{Δ}{2} ) ,$$

which is shown by way of line 914. When the difference signal 912 reaches the threshold line 914, a quantized difference signal is produced and provided to the pulse generator (e.g., 622). In the bottom graph 920, the output train of impulses generated by the pulse generator is shown. As such, when the difference signal 912 reaches the threshold, the pulse generator generates a corresponding transmit signal in the form of a pulse 922. In this example, the reconstructed signal ŷ_{L}(t) (904) and the output train of impulse functions (e.g., 922) are negative valued, which enables tracking of a negative valued input signal y(t) (902).

FIG. 10 is a block diagram illustrating an exemplary APM 1000 in accordance with aspects of the present disclosure. The APM 1000 includes similar elements and components to those shown in FIG. 6. In the example of FIG. 10, the APM 1000 includes a double-sided quantizer 1020. With double-sided quantizers, the transmit pulses can be either positive- or negative-valued resulting in bipolar transmit signals. In some aspects, the additional feature of the decaying reconstruction filter can facilitate decays toward zero from either above (when the input signal is positive and decaying) or below (when the input signal is negative and decaying towards zero). As such, one potential application of such an APM 1000 is in ultrasound applications with an exponential decay of the ultrasound signal amplitude in both positive and negative valued regions.

An additional benefit of using a decaying-type reconstruction filter (in place of the unit-step function) is provided with respect to false detection or missed transmissions. In these cases, the effect of the detection error at the decoder persists only for the time duration of the reconstruction filter response. In the case of the unit-step function, the error persists indefinitely (or until a reset of the system occurs) whereas, for finite duration filter responses or those with infinite durations, but where the majority of the energy (e.g. 99%) has a finite duration (such as the decaying exponential function), the error effectively persists for a finite time.

For example, if the input signal is in the positive region, a combination of the decaying filter and the negative-valued transmit pulses decreases the reconstructed signal value toward zero. In contrast, with a non-decaying reconstruction filter, only the negative transmit pulses would be able to lower the reconstruction signal. Only the positive valued transmit pulse pushes the reconstructed signal upwards. Likewise, if the input signal is in the negative region, a combination of the decaying filter and the positive-valued transmit pulses increases the reconstructed signal value toward zero. Only the negative-valued transmit pulse pushes the reconstructed signal downwards away from zero.

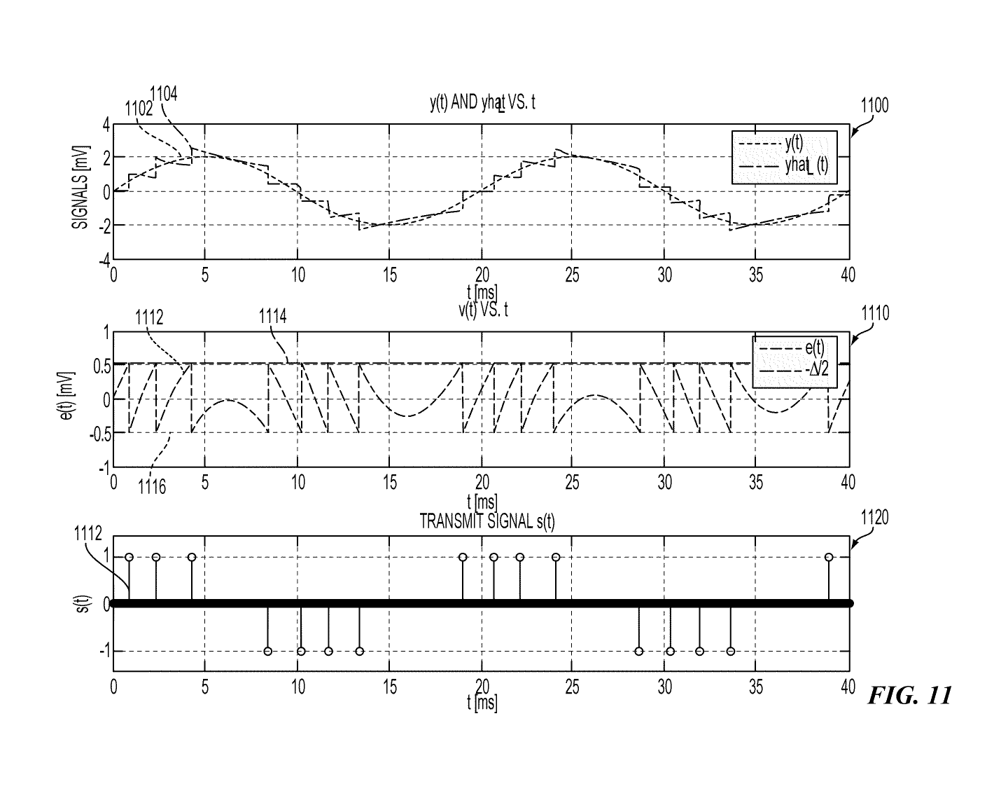

FIG. 11 shows graphs illustrating operation of an exemplary APM with a double-sided quantizer in accordance with aspects of the present disclosure. In the upper graph 1100 of FIG. 11, a sinusoidal input signal 1102 is superimposed with the reconstruction signal 1104. The input signal y(t) may, for example, take the form of a positive valued sinusoid given by:

$$y ( t ) = 2 cos ( 2 π {f}_{c} t - \frac{π}{2} ) . \qquad ( 27 )$$

The reconstruction signal ŷ_{L}(t) 1104 may be produced via a double exponential reconstruction filter, such as that provided in equation (22), for example. Notably, the reconstructed signal decays toward zero.

The middle graph 1110 shows the difference signal e(t) 1112 computed based on the input signal 1102 and the reconstruction signal 1104. In this example, the double-sided quantizer includes a first threshold

$$( \frac{Δ}{2} )$$

and a second threshold

$$( - \frac{Δ}{2} ) ,$$

which is shown by way of lines 1114 and 1116, respectively. Although shown as having the same absolute value, the thresholds are not limited to −Δ/2 and Δ/2. For example, the thresholds may be differentially set (e.g., −Δ/2,Δ) or may be set to a different value (e.g., −Δ,Δ). Furthermore, one or both sides may also be configured with multiple thresholds if desired. When the difference signal 1112 reaches the threshold 1114, a quantized difference signal is produced and provided to the pulse generator (e.g., 622). Similarly, when the difference signal 1112 reaches the second threshold 1116, a quantized difference signal is produced and provided to the pulse generator (e.g., 622).

In the bottom graph 1120, the output train of bipolar impulses generated by the pulse generator is shown. As such, when the difference signal 1112 reaches the threshold (e.g., 1114 and 1116), the pulse generator generates a corresponding transmit signal in the form of a pulse 1122. In this example, the reconstructed signal ŷ_{L}(t) (1104) and the output train of impulse functions (e.g., 1122) are bipolar. That is, in contrast to either the lower-threshold (FIG. 6) or upper-threshold quantized (FIG. 8) approaches, in this exemplary configuration, the APM produces both positive and negative transmit signals. Thus, changes in the signal level are managed by both the decay feature of the reconstruction filter and the positive and negative transmit signals.

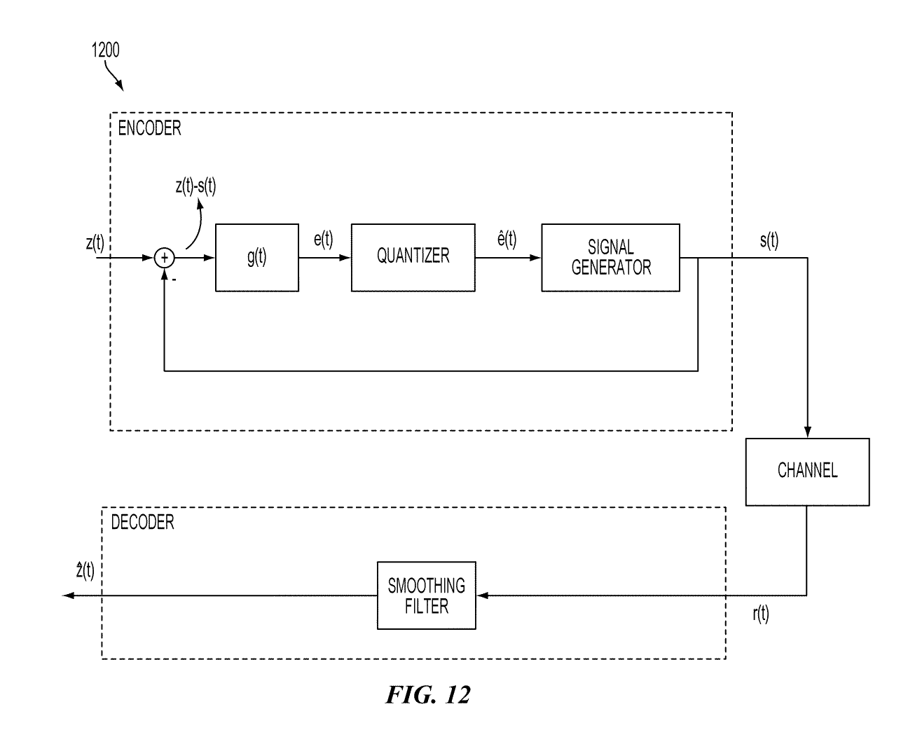

FIG. 12 is a block diagram illustrating a simplified APM 1200 in accordance with aspects of the present disclosure. In contrast to the APM 400 shown in FIG. 4, the pre-filter g(t) and the reconstruction filter h(t) can be moved after the adder due to linearity, when h(t)=g(t). In addition, at the decoder, because h(t) is equal to g(t), the reconstruction filter and the inverse filter cancel each other out (e.g.,

$$G ( f ) \cdot \frac{1}{G ( f )} = 1$$

) leaving only the smoothing filter. As such, the time for comparing of the input signal z(t) and the output signal s(t) may be reduced because the APM is operated without reconstructing the input signal.

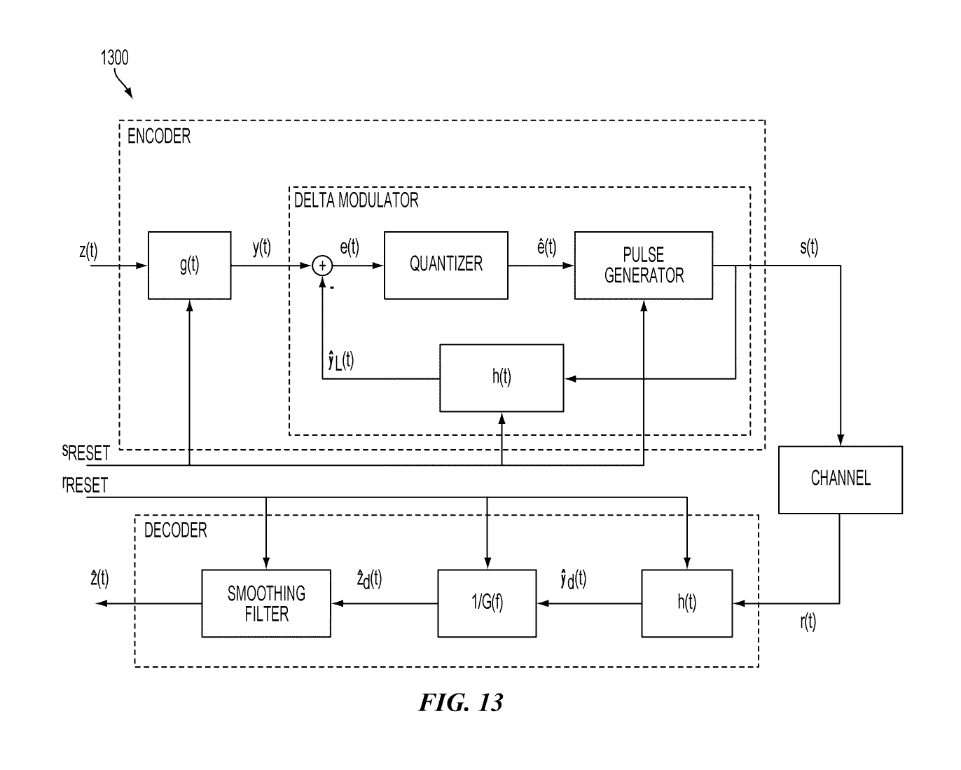

FIG. 13 is a block diagram illustrating an exemplary APM 1300 including a reset mechanism in accordance with aspects of the present disclosure. As shown in FIG. 13, the APM 1300, which includes similar elements and components as shown in FIG. 4, is further configured to receive reset inputs (e.g., sᵣₑₛₑₜ and rᵣₑₛₑₜ). The sᵣₑₛₑₜ input, when activated (e.g., set to 1 for a certain period of time) clears the contents and/or memory of the pre-filter (e.g., 416), local reconstruction filter (e.g., 424) and pulse generator (e.g., 422) at the encoder. For example, if the reconstruction filter is the single decaying exponential in the form of a resistor-capacitor (RC) circuit, the capacitor may be shorted to clear it of any charge. The rᵣₑₛₑₜ input, when activated clears the contents and/or memory of the reconstruction filter (h(t)), inverse pre-filter and smoothing filter at the decoder 412.

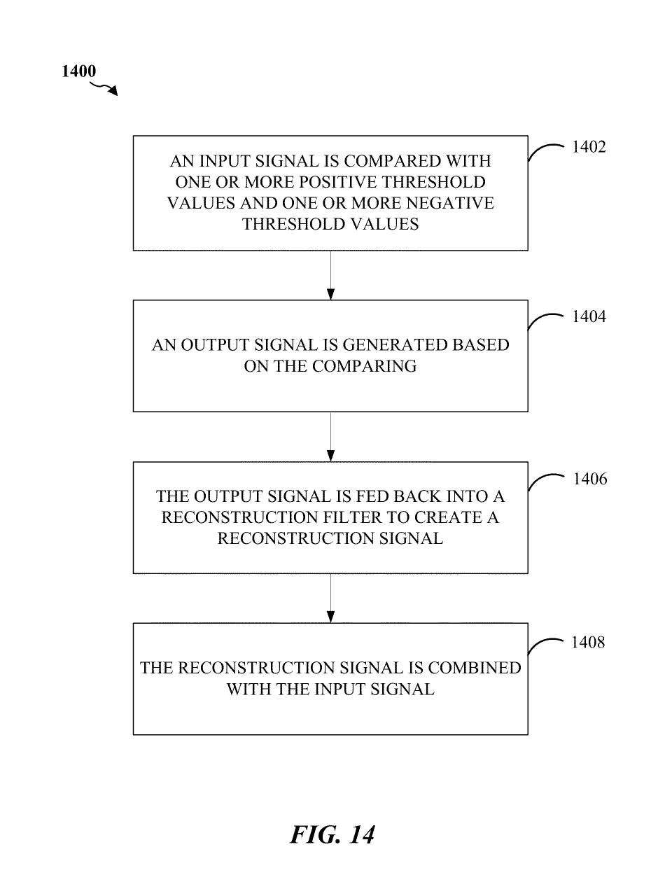

FIG. 14 illustrates a method 1400 for signal processing in accordance with an aspect of the present disclosure. In block 1402, an input signal is compared with one or more positive threshold values and one or more negative threshold values. In some aspects, the input signal may be subjected to a pre-filter (e.g., a sigma filter) before being compared with the thresholds.

In block 1404, an output signal is generated based on the comparing. In block 1406, the output signal is fed back into a reconstruction filter to create a reconstruction signal. In some aspects, the reconstruction filter may be a decaying reconstruction filter. In block 1408, the reconstruction signal is combined with the input signal.

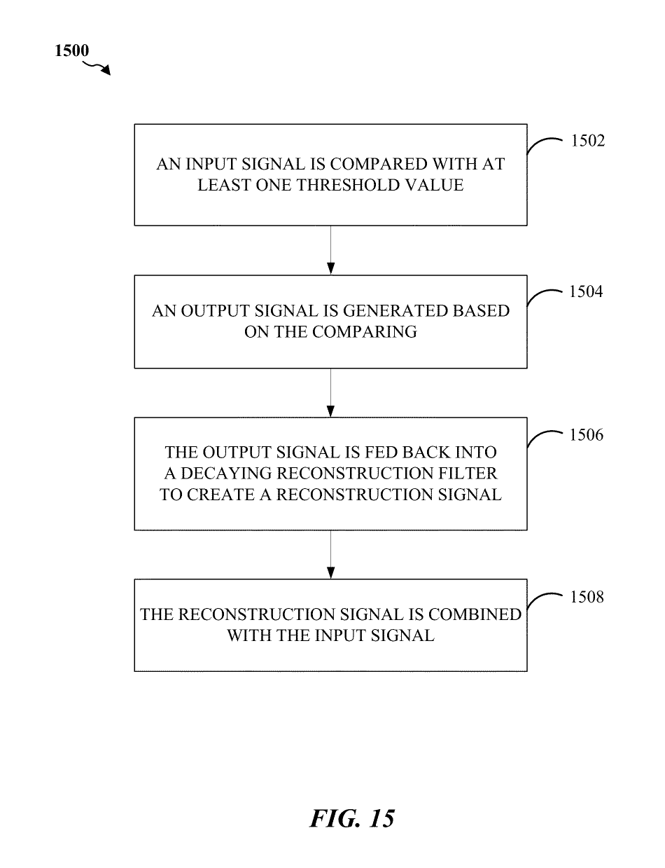

FIG. 15 illustrates a method 1500 for signal processing in accordance with an aspect of the present disclosure. In block 1502, an input signal is compared with one or more threshold values. In some aspects, the input signal may be subjected to a pre-filter (e.g., a sigma filter) before being compared with the thresholds.

In block 1504, an output signal is generated based on the comparing. In block 1506, the output signal is fed back into a decaying reconstruction filter to create a reconstruction signal. The reconstruction filter is other than a single decaying exponential. In block 1508, the reconstruction signal is combined with the input signal.

The various operations of methods described above may be performed by any suitable means capable of performing the corresponding functions. A device in accordance with an aspect of the present disclosure includes means for comparing an input signal with one or more positive threshold values and one or more negative threshold values. The comparing means may be, for example, the encoder 14, the quantizer 420, the quantizer 1020, and the quantizer 1320. Such a device also includes means for generating an output signal based on the comparing. The generating means may be, for example, the signal generator 422 as shown in FIG. 4. Such a device also includes means feeding back the output signal into a decaying reconstruction filter to create a decaying reconstructed signal. The feedback means may include, for example, the reconstruction filter 424 as shown in FIG. 4. The device also includes means for combining the decaying reconstructed signal with the input signal. The combining means may be the summation block (adder 428) shown in FIG. 4. Other devices may perform the functions of the means described. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

In another configuration, a device in accordance with an aspect of the present disclosure includes means for comparing an input signal with one or more threshold values. The comparing means may be, for example, the encoder 14, the quantizer 420, the quantizer 612, the quantizer 820, the quantizer 1020, and the quantizer 1320. Such a device also includes means for generating an output signal based on the comparing. The generating means may be, for example, the signal generator 422 as shown in FIG. 4. Such a device also includes means feeding back the output signal into a decaying reconstruction filter to create a decaying reconstructed signal. The feedback means may include, for example, the reconstruction filter 424 as shown in FIG. 4. The device also includes means for combining the decaying reconstructed signal with the input signal. The combining means may be the summation block (adder) shown in FIG. 4. Other devices may perform the functions of the means described. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

Optionally, the decoder 412, when it receives the received signal 414, can echo or otherwise return a signal to the encoder 402, for example, an “Acknowledgment” on a reverse channel. The acknowledgement may be configured to operate only on the first received signal 414 after a period of not receiving a signal (i.e., silence) for a pre-determined or periodic amount of time (e.g. >2 secs). The acknowledgement signal may also be requested by the encoder 402.

The thresholds Δ can be varied by the encoder 402 and the decoder 412 to adjust for the desired level of accuracy (also referred to as “reconstruction error”). If the thresholds are set to larger values, there will be a smaller correlation between the input signal 404 and the output signal 408. The threshold values may also be exchanged between the encoder 402 and the decoder 412 via an overhead signaling message.

The output signal can also be in the form of an address event representation (AER) packet that may include time-stamp information of the event (threshold crossing) and/or which threshold was crossed by the input signal. For example, in a bipolar quantizer, it can be indicated whether the positive or negative threshold was crossed.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices (e.g., a combination of a DSP and a microprocessor, a plurality of microprocessors, one or more microprocessors in conjunction with a DSP core, or any other such configuration).

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of signal processing, comprising:
comparing an input signal with at least one positive threshold value and at least one negative threshold value;
generating an output signal based at least in part on the comparing;
feeding back the output signal into a decaying reconstruction filter to create a reconstructed signal; and
combining the reconstructed signal with the input signal.

2. The method of claim 1, in which generating the output signal comprises generating the output signal when the input signal crosses the at least one positive threshold value or the at least one negative threshold value.

3. The method of claim 1, in which the generating is performed in a neural network.

4. The method of claim 1, further comprising decoding the output signal.

5. The method of claim 4, in which decoding the output signal comprises inputting the output signal into a decaying filter to create a decoded signal; and
filtering the decoded signal with a filter having a bandwidth at least as wide as the input signal.

6. The method of claim 5, further comprising pre-filtering the input signal at an encoder, and inversely pre-filtering the output signal at a decoder.

7. The method of claim 1, in which the output signal further comprises an address event representation (AER) packet.

8. The method of claim 7, in which the AER packet comprises at least one of time stamp information and an indication of a threshold crossed by the input signal.

9. A method of signal processing, comprising:
comparing an input signal with at least one threshold value;
generating an output signal based at least in part on the comparing;
feeding back the output signal into a decaying reconstruction filter to create a reconstructed signal, in which the decaying reconstruction filter is other than a single decaying exponential; and
combining the reconstructed signal with the input signal.

10. The method of claim 9, in which generating the output signal comprises generating the output signal when the input signal crosses the at least one threshold value.

11. The method of claim 9, in which the generating is performed in a neural network.

12. The method of claim 9, further comprising decoding the output signal.

13. The method of claim 12, in which decoding the output signal comprises inputting the output signal into a decaying filter to create a decoded signal; and
filtering the decoded signal with a filter having a bandwidth at least as wide as the input signal.

14. The method of claim 13, further comprising pre-filtering the input signal at an encoder, and inversely pre-filtering the output signal at a decoder.

15. The method of claim 9, in which the output signal further comprises an address event representation (AER) packet.

16. The method of claim 15, in which the AER packet comprises at least one of time stamp information and an indication of a threshold crossed by the input signal.

17. An apparatus for signal processing, comprising:
a memory; and
at least one processor coupled to the memory, the at least one processor being configured:
to compare an input signal with at least one positive threshold value and at least one negative threshold value;
to generate an output signal based at least in part on the comparing;
to feed back the output signal into a decaying reconstruction filter to create a reconstructed signal; and
to combine the reconstructed signal with the input signal.

18. The apparatus of claim 17, in which the at least one processor is further configured to generate the output signal when the input signal crosses the at least one positive threshold value or the at least one negative threshold value.

19. The apparatus of claim 17, in which the at least one processor is further configured to generate the output signal in a neural network.

20. The apparatus of claim 17, in which the at least one processor is further configured to decode the output signal.

21. The apparatus of claim 20, in which the at least one processor is further configured:
to input the output signal into a decaying filter to create a decoded signal; and
to filter the decoded signal with a filter having a bandwidth at least as wide as the input signal.

22. The apparatus of claim 21, in which the at least one processor is further configured to pre-filter the input signal at an encoder, and inversely pre-filter the output signal at a decoder.

23. The apparatus of claim 17, in which the output signal further comprises an address event representation (AER) packet.

24. The apparatus of claim 23, in which the AER packet comprises at least one of time stamp information and an indication of a threshold crossed by the input signal.

25. An apparatus for signal processing, comprising:
a memory; and
at least one processor coupled to the memory, the at least one processor being configured:
to compare an input signal with at least one threshold value;
to generate an output signal based at least in part on the comparing;
to feed back the output signal into a decaying reconstruction filter to create a reconstructed signal, in which the decaying reconstruction filter is other than a single decaying exponential; and
to combine the reconstructed signal with the input signal.

26. The apparatus of claim 25, in which the at least one processor is further configured to generate the output signal when the input signal crosses the at least one threshold value.

27. The apparatus of claim 25, in which the at least one processor is further configured to generate the output signal in a neural network.

28. The apparatus of claim 25, in which the at least one processor is further configured to decode the output signal.

29. The apparatus of claim 28, in which the at least one processor is further configured:
to input the output signal into a decaying filter to create a decoded signal; and
to filter the decoded signal with a filter having a bandwidth at least as wide as the input signal.

30. The apparatus of claim 29, in which the at least one processor is further configured to pre-filter the input signal at an encoder, and to inversely pre-filter the output signal at a decoder.

31. The apparatus of claim 25, in which the output signal further comprises an address event representation (AER) packet.

32. The apparatus of claim 31, in which the AER packet comprises at least one of time stamp information and an indication of a threshold crossed by the input signal.

33. An apparatus for signal processing, comprising:
means for comparing an input signal with at least one positive threshold value and at least one negative threshold value;
means for generating an output signal based at least in part on the comparing;
means for feeding back the output signal into a decaying reconstruction filter to create a reconstructed signal; and
means for combining the reconstructed signal with the input signal.

34. An apparatus for signal processing, comprising:
means for comparing an input signal with at least one threshold value;
means for generating an output signal based at least in part on the comparing;
means for feeding back the output signal into a decaying reconstruction filter to create a reconstructed signal, in which the decaying reconstruction filter is other than a single decaying exponential; and
means for combining the reconstructed signal with the input signal.

35. A computer program product for signal processing, comprising:
a non-transitory computer readable medium having encoded thereon program code, the program code comprising:
program code to compare an input signal with at least one positive threshold value and at least one negative threshold value;
program code to generate an output signal based at least in part on the comparing;
program code to feed back the output signal into a decaying reconstruction filter to create a reconstructed signal; and
program code to combining the reconstructed signal with the input signal.

36. A computer program product for signal processing, comprising:
a non-transitory computer readable medium having encoded thereon program code, the program code comprising:
program code to compare an input signal with at least one threshold value;
program code to generate an output signal based at least in part on the comparing;
program code to feed back the output signal into a decaying reconstruction filter to create a reconstructed signal, in which the decaying reconstruction filter is other than a single decaying exponential; and
program code to combine the reconstructed signal with the input signal.
